(19) United States
(12) Patent Application Publication
(10) Pub. No.: US 2012/0325266 A1
(43) Pub. Date: Dec. 27, 2012

(54) METHOD OF PREDICTING CLEANING PERFORMANCE AND SUBSTRATE CLEANING METHOD

(76) Inventor: Tomoatsu ISHIBASHI, Tokyo (JP)

(21) Appl. No.: 13/489,732

(22) Filed: Jun. 6, 2012

(30) Foreign Application Priority Data
Jun. 10, 2011 (JP) 2011-130247

(51) Int. Cl. B08B 1/04; G06F 17/10

(52) U.S. Cl. 134/6; 703/2

(57) ABSTRACT

A cleaning performance prediction method determines a first distance from the origin of an X-Y plane to a first cleaning point on the X-Y plane, and the X-Y coordinates being determined for cleaning of the substrate to be carried out under first cleaning conditions. The method also determines a second distance from the origin of the X-Y plane to a second cleaning point on the X-Y plane, the X-Y coordinates of the second cleaning point being determined in the same manner as those of the first cleaning point but for cleaning of the substrate to be carried out under second cleaning conditions different from the first cleaning conditions.

### CROSS REFERENCE TO RELATED APPLICATIONS

This document claims priority to Japanese Application Number 2011-130247, filed Jun. 10, 2011, the entire contents of which are hereby incorporated by reference.

### BACKGROUND OF THE INVENTION

1. Field of the Invention

The present invention relates to a substrate cleaning method and a method of predicting cleaning performance in scrub cleaning of a surface of a substrate, such as a semiconductor wafer, with a long cylindrical roll cleaning member, carried out by rotating the substrate and the roll cleaning member each in one direction while keeping the roll cleaning member in contact with the surface of the substrate in the presence of a cleaning liquid.

The substrate cleaning method and the cleaning performance prediction method of the present invention can be applied, e.g., to cleaning of a surface of a semiconductor wafer or cleaning of a substrate surface in the manufacturing of an LCD (liquid crystal display) device, a PDP (plasma display panel) device or a CMOS image sensor.

2. Description of the Related Art

As semiconductor devices are becoming finer these days, cleaning of various films, made of materials having different physical properties and formed in a substrate, is widely practiced. For example, in a damascene interconnect forming process for forming interconnects in a substrate surface by filling a metal into interconnect trenches formed in an insulating film on the substrate surface, an extra metal on the substrate surface is polished away by chemical mechanical polishing (CMP) after the formation of damascene interconnects. A plurality of films such as a metal film, a barrier film and an insulating film, having different water wetting properties, are exposed on the substrate surface after CMP.

A residue of a slurry (slurry residue) that has been used in CMP, metal polishing debris, etc. exist on the substrate surface having exposed films such as a metal film, a bather film and an insulating film by CMP. If cleaning of the substrate surface is insufficient and residues remain on the substrate surface, the residues on the substrate surface may cause reliability problems such as the occurrence of leak from a residue portion, poor adhesion, etc. It is therefore necessary to clean with a high degree of cleaning the substrate surface on which the plurality of films such as a metal film, a barrier film and an insulating film, having different water wetting properties, are exposed.

As a cleaning method of cleaning a substrate surface after CMP, a scrub cleaning method is known which comprises cleaning a surface of a substrate, such as a semiconductor wafer, with a long cylindrical roll cleaning member (roll sponge or roll brush) by rotating the substrate and the roll cleaning member each in one direction while keeping the roll cleaning member in contact with the surface of the substrate in the presence of a cleaning liquid (see patent literature 1). A roll cleaning member for use in such scrub cleaning generally has a length which is somewhat larger than the diameter of a substrate, and is disposed in a position perpendicular to the rotational axis of the substrate in a cleaning area which is a contact cleaning surface. Cleaning characteristics can be obtained by rubbing the surface of the substrate with the roll cleaning member, i.e., by rotating the substrate on the rotational axis while keeping the roll cleaning member in contact with the surface of the substrate over the entire length in the diametrical direction.

In order to achieve a high cleaning effect while reducing unevenness in the cleaning performance in a substrate surface, a substrate cleaning technique has been proposed which uses two cleaning brushes (roll cleaning members) that rotate on the same rotational axis but in opposite directions, and performs scrub cleaning of a substrate surface by independently bringing the two cleaning brushes into contact with the substrate surface while rotating the cleaning bushes and the substrate (see patent literature 2).

### CITATION LIST

### Patent Literature

Patent literature 1: Japanese Patent Laid-open Publication No. H10-308374
Patent literature 2: Japanese Patent Laid-open Publication No. 2010-212295

### SUMMARY OF THE INVENTION

In a conventional common semiconductor device structure to be subjected to CMP processing, tungsten or aluminum has been mainly used as a metal in an interconnect portion, and an oxide film has been mainly used as an insulating film in an insulating portion. Interconnects (e.g., tungsten) and an insulating film (oxide film), which become exposed on a substrate surface by CMP processing, have hydrophilic surface properties. A cleanliness evaluation using a hydrophilic film has therefore been widely used for evaluation of scrub cleaning of such a substrate surface by a roll cleaning member.

These days copper as an interconnect material and a so-called low-k film having a low dielectric constant as an insulating film have come to be used in damascene interconnects. Copper and a low-k film have hydrophobic surface properties. Thus, because of unevenness in the wetting properties of a substrate surface after CMP, on which copper and a low-k film are exposed, it is difficult to clean the substrate surface with a high degree of cleaning by scrub cleaning using a roll cleaning member.

In particular, as shown in FIG. 1, the contact angle of an acidic cleaning liquid with respect to a surface of a low-k film after CMP (angle between the surface of the low-k film and the tangent to a liquid droplet) is 40.9°, the contact angle of a neutral cleaning liquid with respect to the surface of the low-k film is 43.0°, and the contact angle of an alkaline cleaning liquid with respect to the surface of the low-k film is 46.1°. The fact that the contact angles of the various cleaning liquids exceed 25° indicates that the low-k material has hydrophobic surface properties.

Further, as shown in FIG. 2, the contact angles of a cleaning liquid A with respect to the surfaces of the low-k film and copper after CMP are 43.0° and 32.6°, respectively, and the contact angles of a cleaning liquid B with respect to the surfaces of the low-k film and copper are 46.1° and 58.8°, respectively. The contact angles of the cleaning liquids thus exceed 25° not only with respect to the surface of the low-k film but also with respect to the surface of copper, indicating that the both of the low-k film and copper have hydrophobic surface properties.

The overall cleaning characteristics are determined by the total cleaning performance of the cleaning performance of a cleaning liquid and the physical cleaning performance, and by the effect of preventing residues, etc. from re-adhering to a substrate surface. In the case of a hydrophobic substrate surface, enhancement of the physical cleaning performance is of great importance in view of poor wetting properties of the surface. In scrub cleaning which performs physical cleaning of a substrate surface by using a roll cleaning member, contamination of the substrate surface by contact of the roll cleaning member with the substrate surface should also be taken into consideration. Thus, it is preferred to secure the cleaning performance to remove primary intended matter (such as defects) while minimizing such back contamination of the substrate surface.

Experimental scrub cleaning, which performs physical cleaning by using a roll cleaning member, of a hydrophilic substrate surface, in particular a surface of an oxide film, was conducted under the cleaning conditions suited for hydrophilic substrate surface. For comparison, experimental scrub cleaning of a hydrophobic substrate surface was conducted under the same cleaning conditions. For each substrate after cleaning, the number of defects remaining on the substrate surface was measured. The results of measurement show a significant difference in the number of defects between the samples tested.

FIG. 3 shows correlation data between the measured contact angle of a cleaning liquid with respect to a substrate surface and the number of defects remaining on the substrate surface after performing scrub cleaning of the substrate surface using the cleaning liquid, determined for various substrate surfaces with varying contact angles of the cleaning liquid. As can be seen in FIG. 3, the number of defects remaining on a substrate surface differs greatly depending on a deference in the substrate surface properties, i.e., whether the substrate surface has hydrophilic properties or hydrophobic properties; the more hydrophobic the substrate surface is, the larger is the number of defects.

Defects remaining on a substrate surface after cleaning may incur a lowering of the yield of a semiconductor device. Therefore, a strong demand exists for the development of a substrate cleaning method which can clean a substrate surface with a high degree of cleaning and reduce the number of defects remaining on the substrate surface even when the substrate surface has hydrophobic properties, such as a hydrophobic substrate surface after CMP carried out in a semiconductor device manufacturing process.

The use of two cleaning brushes (roll cleaning members) which rotate on the same rotational axis but in opposite directions, as described in the patent literature 2, necessitates individual control of each of the two cleaning brushes. This makes the construction of the cleaning apparatus complicated and also makes control of the cleaning apparatus cumbersome.

In a substrate cleaning method which performs scrub cleaning of a substrate surface by bringing a roll cleaning member, having a length that covers the diameter of the substrate, into contact with the substrate surface in a cleaning area along the axial direction of the roll cleaning member while rotating the roll cleaning member and the substrate each in one direction, cleaning is not performed in the same cleaning mode in the cleaning area: An area where the relative velocity between the roll cleaning member and the substrate is negative, an area where the relative velocity is positive and an area where the relative velocity is zero can exist in the cleaning area. Thus, cleaning of the substrate surface in the cleaning area is performed in a very complicated mode. Therefore, it has been difficult to predict, without actually performing cleaning, how the cleaning effect will change by making a change to the cleaning conditions.

The present invention has been made in view of the above situation. It is therefore a first object of the present invention to provide a cleaning performance prediction method which makes it possible to easily predict, without actually performing cleaning, how the cleaning effect will change by making a change to cleaning conditions.

It is a second object of the present invention to provide a substrate cleaning method which makes it possible to efficiently clean a substrate surface with a high degree of cleaning and reduce the number of defects remaining on the substrate surface even when the substrate surface has hydrophobic properties.

The present invention provides a method of predicting cleaning performance in scrub cleaning of a surface of a substrate, carried out by positioning a role cleaning member, having a length that covers a diameter of the substrate, on the rotational axis of the substrate, and rotating the roll cleaning member and the substrate each in one direction while keeping the roll cleaning member in contact with the surface of the substrate in a cleaning area along the axial direction of the roll cleaning member, said method comprising: determining a first distance from the origin of an X-Y plane to a first cleaning point on the X-Y plane, the X coordinate of the first cleaning point being the distance from the rotational axis of the substrate to a direction-reversing point on the cleaning area at which the relative velocity between the roll cleaning member and the substrate is zero and the direction of cleaning reverses, the Y coordinate of the first cleaning point being the amount of the relative velocity, defined in terms of an area, and the X-Y coordinates being determined for cleaning of the substrate to be carried out under first cleaning conditions in which the roll cleaning member and the substrate are rotated each at a predetermined rotational velocity; determining a second distance from the origin of the X-Y plane to a second cleaning point on the X-Y plane, the X coordinate of the second cleaning point being the distance from the rotational axis of the substrate to a direction-reversing point on the cleaning area at which the relative velocity between the roll cleaning member and the substrate is zero and the direction of cleaning reverses, the Y coordinate of the second cleaning point being the amount of the relative velocity, defined in terms of an area, and the X-Y coordinates being determined for cleaning of the substrate to be carried out under second cleaning conditions different from the first cleaning conditions; and, if the second distance is longer than the first distance, predicting that the number of defects remaining on the substrate surface will be smaller when cleaning the substrate under the second cleaning conditions than when cleaning the substrate under the first cleaning conditions.

The present invention also provides a substrate cleaning method comprising: positioning a role cleaning member, having a length that covers a diameter of a substrate, on the rotational axis of the substrate, and rotating the roll cleaning member and the substrate each in one direction while keeping the roll cleaning member in contact with a surface of the substrate in a cleaning area along the axial direction of the roll cleaning member, thereby performing scrub cleaning of the surface of the substrate with the roll cleaning member. During the cleaning of the substrate, the roll cleaning member and the substrate are rotated in such a manner that the following relational expressions are satisfied:

0<a<L/6,

(Dᵢ+D_{f})≧8L,

where D_{f} (mm) is a relative movement distance per second, determined by the maximum relative velocity V_{f} (mm/sec) in a forward-direction cleaning area, where the relative velocity between the roll cleaning member and the substrate is relatively low, of the cleaning area, Dᵢ (mm) is a relative movement distance per second, determined by the maximum relative velocity Vᵢ (mm/sec) in an opposite-direction cleaning area, where the relative velocity between the roll cleaning member and the substrate is relatively high, of the cleaning area, L (mm) is the length of the cleaning area, and a (mm) is the distance from the rotational axis of the substrate to a direction-reversing point on the cleaning area at which the relative velocity between the roll cleaning member and the substrate is zero and the direction of cleaning reverses; and

S≧2000L,

where S (mm²) is the amount of relative velocity, which is the total area Sᵣᵥ of the following areas Sᵢ and S_{f}: the area Sᵢ (mm²) of a triangle with a length L₁ as the base and the relative movement distance Dᵢ (mm) per second, determined by the maximum relative velocity Vᵢ (mm/sec), as the height, the length L₁ (mm) being the length of an opposite relative movement area of the cleaning area, lying on the opposite-direction cleaning area side of the direction-reversing point; and the area S_{f} (mm²) of a triangle with a length L₂ as the base and the relative movement distance D_{f} (mm) per second, determined by the maximum relative velocity V_{f} (mm/sec), as the height, the length L₂ (mm) being the length of a forward relative movement area of the cleaning area, lying on the forward-direction cleaning area side of the direction-reversing point.

The present invention also provides another substrate cleaning method comprising: positioning a role cleaning member, having a length that covers a diameter of a substrate, on the rotational axis of the substrate, and rotating the roll cleaning member and the substrate each in one direction while keeping the roll cleaning member in contact with a surface of the substrate in a cleaning area along the axial direction of the roll cleaning member, thereby performing scrub cleaning of the surface of the substrate with the roll cleaning member. During the cleaning of the substrate, the roll cleaning member and the substrate are rotated in such a manner that the following relational expressions are satisfied:

L/6≦a≦L/2,

(Dᵢ+D_{f})≧8L,

where D_{f} (mm) is a relative movement distance per second, determined by the maximum relative velocity V_{f} (mm/sec) in a forward-direction cleaning area, where the relative velocity between the roll cleaning member and the substrate is relatively low, of the cleaning area, Dᵢ (mm) is a relative movement distance per second, determined by the maximum relative velocity Vᵢ (mm/sec) in an opposite-direction cleaning area, where the relative velocity between the roll cleaning member and the substrate is relatively high, of the cleaning area, L (mm) is the length of the cleaning area, and a (mm) is the distance from the rotational axis of the substrate to a direction-reversing point on the cleaning area at which the relative velocity between the roll cleaning member and the substrate is zero and the direction of cleaning reverses; and

S≦1300L,

where S (mm²) is the amount of relative velocity, which is the total area Sᵣ, of the following areas Sᵢ and S_{f}: the area Sᵢ (mm²) of a triangle with a length L₁ as the base and the relative movement distance Dᵢ (mm) per second, determined by the maximum relative velocity Vᵢ (mm/sec), as the height, the length L₁ (mm) being the length of an opposite relative movement area of the cleaning area, lying on the opposite-direction cleaning area side of the direction-reversing point; and the area S_{f} (mm²) of a triangle with a length L₂ as the base and the relative movement distance D_{f} (mm) per second, determined by the maximum relative velocity V_{f} (mm/sec), as the height, the length L₂ (mm) being the length of a forward relative movement area of the cleaning area, lying on the forward-direction cleaning area side of the direction-reversing point.

The present invention also provides yet another substrate cleaning method comprising: positioning a role cleaning member, having a length that covers a diameter of a substrate, on the rotational axis of the substrate, and rotating the roll cleaning member and the substrate each in one direction while keeping the roll cleaning member in contact with a surface of the substrate in a cleaning area along the axial direction of the roll cleaning member, thereby performing scrub cleaning of the surface of the substrate with the roll cleaning member. During the cleaning of the substrate, the roll cleaning member and the substrate are rotated in such a manner that a direction-reversing point, at which the relative velocity between the substrate and the roll cleaning member is zero and the direction of cleaning reverses, does not exist on the cleaning area.

Preferably, the roll cleaning member and the substrate are rotated during the cleaning of the substrate in such a manner that the following relational expression is satisfied:

(Dᵢ+D_{f})≧4L,

where D_{f} (mm) is a relative movement distance per second, determined by the maximum relative velocity V_{f} (mm/sec) in a forward-direction cleaning area, where the relative velocity between the roll cleaning member and the substrate is relatively low, of the cleaning area, Dᵢ (mm) is a relative movement distance per second, determined by the maximum relative velocity Vᵢ (mm/sec) in an opposite-direction cleaning area, where the relative velocity between the roll cleaning member and the substrate is relatively high, of the cleaning area, and L (mm) is the length of the cleaning area.

More preferably, the roll cleaning member and the substrate are rotated during the cleaning of the substrate in such a manner that the following relational expression is satisfied:

S≧600L,

where S (mm²) is the amount of relative velocity, which is the area Sᵣᵥ of a trapezoid with the relative movement distance D_{f} (mm) per second, determined by the maximum relative velocity V_{f} (mm/sec), as the upper base, the relative movement distance Dᵢ (mm) per second, determined by the maximum relative velocity Vᵢ, as the lower base, and the length L of the cleaning area as the height.

According to the cleaning performance prediction method of the present invention, it becomes possible to easily predict, without actually performing cleaning, how the cleaning effect will change by making a change to cleaning conditions, thus making it possible to determine optimal cleaning conditions. In addition, with reference to a low-k film that is generally expensive and hard to predict the cleaning performance, the number of defects remaining on a substrate surface after cleaning of the surface of the low-k film can be predicted, without actually performing a costly cleaning test, based on a predicted cleaning effect on a common hydrophobic film that can be prepared with ease.

According to the substrate cleaning method of the present invention, it becomes possible to efficiently clean a substrate surface with a high degree of cleaning and reduce the number of defects remaining on the substrate surface even when the substrate surface has hydrophobic properties.

### BRIEF DESCRIPTION OF THE DRAWINGS

FIG. 1 is a diagram showing the contact angles of typical acidic, neutral and alkaline cleaning liquids with respect to a surface of a low-k film after CMP;

FIG. 2 is a diagram showing the contact angles of a cleaning liquid A and a cleaning liquid B with respect to surfaces of a low-k film and copper after CMP;

FIG. 3 is a graph showing correlation data between the measured contact angle of a cleaning liquid with respect to a substrate surface and the number of defects remaining on the substrate surface after scrub cleaning of the substrate surface using the cleaning liquid, determined for various substrate surfaces with varying contact angles of the cleaning liquid;

FIG. 4 is a schematic view of an exemplary scrub cleaning apparatus for use in a cleaning performance prediction method and a substrate cleaning method according to the present invention;

FIG. 5 is a schematic view illustrating the relationship between a substrate and a roll cleaning member in the scrub cleaning apparatus shown in FIG. 4;

FIG. 6 is a plan view illustrating the relationship between a substrate and a roll cleaning member in the scrub cleaning apparatus shown in FIG. 4;

FIG. 7A is a cross-sectional view illustrating a substrate and a roll cleaning member, together with their rotational velocities, in a forward-direction cleaning area, and FIG. 7B is a cross-sectional view illustrating the substrate and the roll cleaning member, together with their rotational velocities, in an opposite-direction cleaning area;

FIG. 8 is a diagram illustrating a method to determine the amount (area) of relative movement when a direction-reversing point, at which the direction of cleaning reverses, exits on the cleaning area;

FIG. 9 is a diagram illustrating a method to determine the amount (area) of relative movement when a direction-reversing point, at which the direction of cleaning reverses, does not exit on the cleaning area;

FIG. 10 is a diagram showing various cleaning conditions used in cleaning of a surface of a low-k film on a substrate and a surface of another common hydrophobic film on a substrate, carried out by using the substrate cleaning apparatus shown in FIG. 4, and the results of measurement of the number of defects remaining on the substrate surface after cleaning;

FIG. 11 is a graph showing the relationship between the number of defects remaining on a substrate surface after cleaning and the cleaning conditions shown in FIG. 10 used in cleaning of a surface of a low-k film on a substrate and a surface of another common hydrophobic film on a substrate;

FIG. 12 is a graph showing various cleaning conditions used in cleaning of a surface of a low-k film on a substrate, and the number of defects remaining on the substrate surface and the amount of relative velocity in the respective cleaning conditions, together with the distance from the rotational axis of the substrate to a direction-reversing point at which the relative velocity between a roll cleaning member and a substrate is zero, the distance being expressed in terms of the ratio to the length of the cleaning area;

FIG. 13 is a diagram showing the relationship, in various cleaning conditions, between the amount of relative velocity and the distance from the rotational axis of the substrate to a direction-reversing point at which the relative velocity between a roll cleaning member and a substrate is zero;

FIG. 14 is a diagram illustrating a method to determine the distance from the origin of an X-Y plane to a cleaning point, corresponding to certain cleaning conditions, plotted on the X-Y plane;

FIG. 15 is a graph showing the relationship between the distance from the origin of the X-Y plane to the cleaning point, shown in FIG. 14, and the number of defects remaining on a surface after cleaning of the surface of a low-k film on a substrate, carried out under the cleaning conditions corresponding to the cleaning point;

FIG. 16 is a flow chart showing an exemplary cleaning performance prediction method according to the present invention;

FIG. 17 is a diagram showing the number of defects remaining on a surface after cleaning of the surface of a common hydrophobic film on a substrate, together with the various cleaning conditions used, the ratio (a/L) of the distance from the rotational axis of the substrate to a direction-reversing point, at which the relative velocity between a roll cleaning member and the substrate is zero and the direction of cleaning reverses, to the length of the cleaning area, the sum of the relative movement distances per second (Dᵢ+D_{f}), determined by the maximum relative velocities in the opposite-direction cleaning area and the forward-direction cleaning area, and the amount (S) of relative velocity;

FIG. 18 is a diagram showing the number of defects remaining on a surface after cleaning of the surface of a low-k film on a substrate, together with the various cleaning conditions used, the ratio (a/L) of the distance from the rotational axis of the substrate to a direction-reversing point, at which the relative velocity between a roll cleaning member and the substrate is zero and the direction of cleaning reverses, to the length of the cleaning area, the sum of the relative movement distances per second (Dᵢ+D_{f}), determined by the maximum relative velocities in the opposite-direction cleaning area and the forward-direction cleaning area, and the amount (S) of relative velocity; and

FIG. 19 is a graph showing the relationship of the contact pressure between a substrate and a roll cleaning member with the number of defects remaining on a surface of the substrate after cleaning with the roll cleaning member, carried out at varying contact pressures between the substrate and the roll cleaning member.

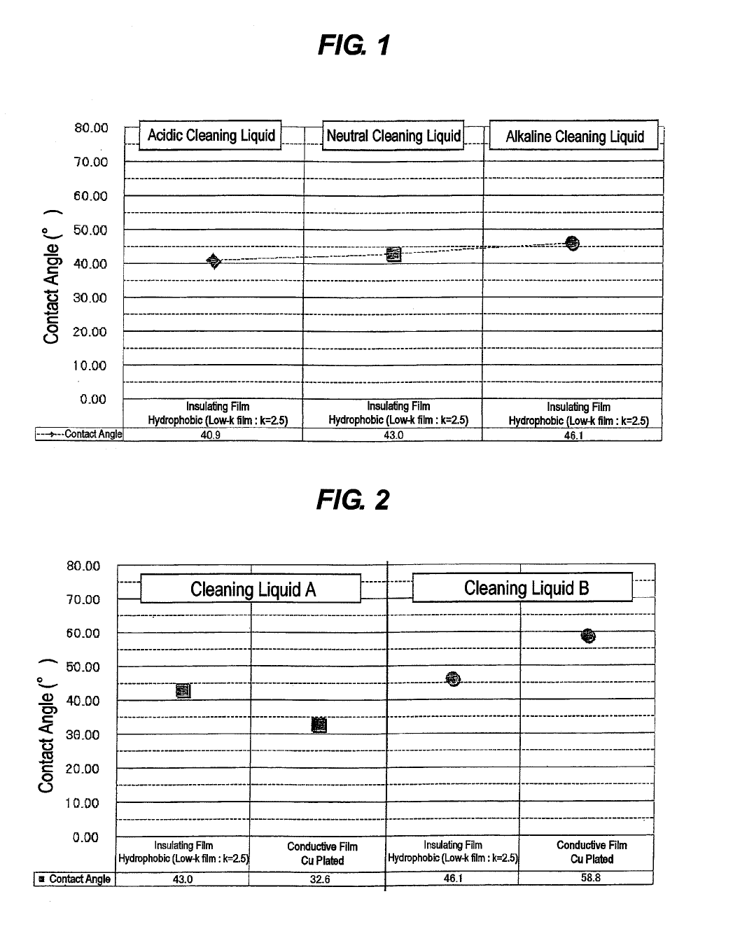

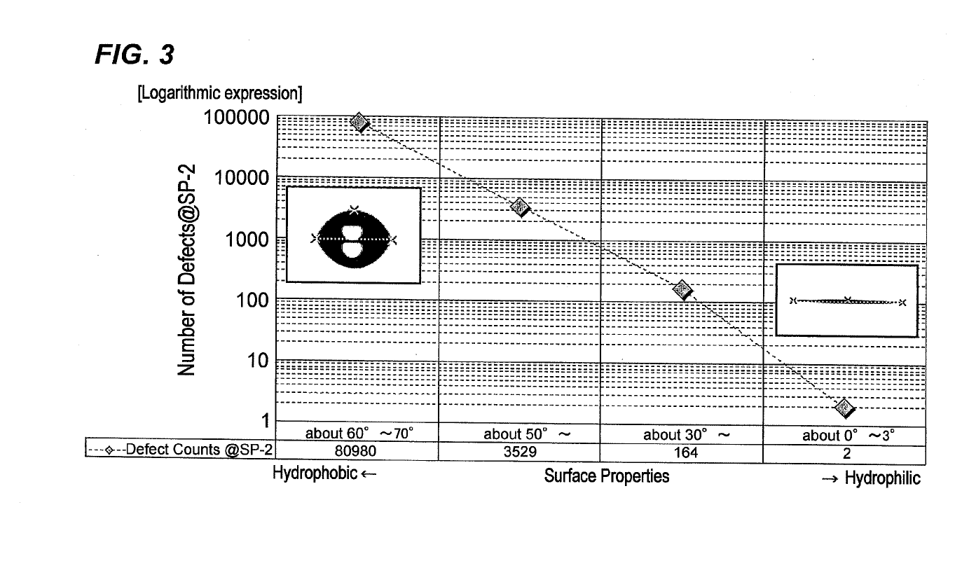

### DETAILED DESCRIPTION OF THE PREFERRED EMBODIMENTS

Preferred embodiments of the present invention will now be described with reference to the drawings.

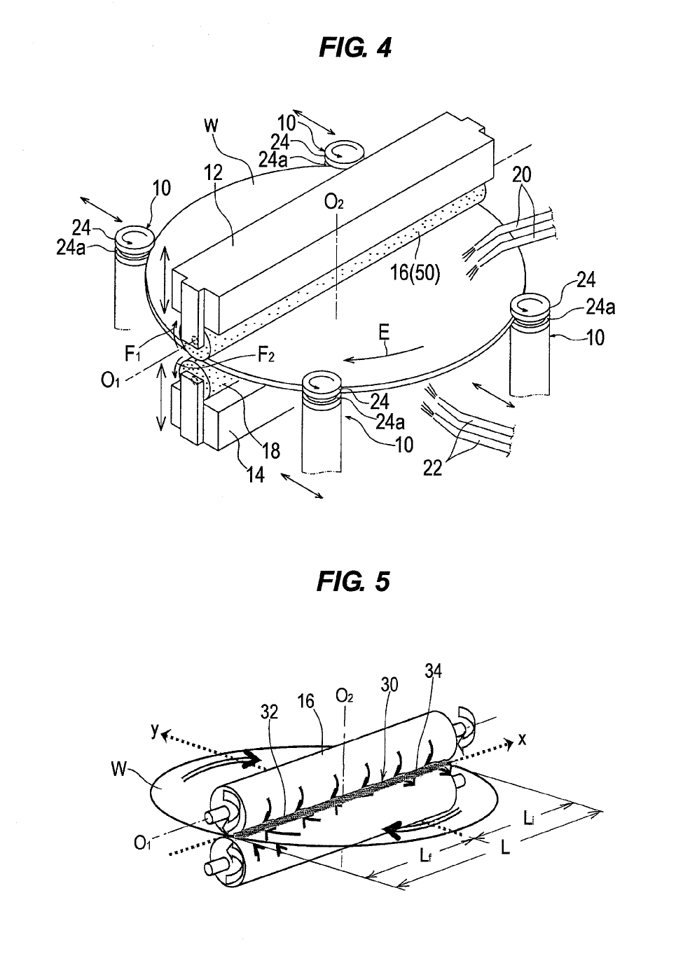

FIG. 4 is a schematic view of an exemplary scrub cleaning apparatus for use in a method of predicting cleaning performance and a substrate cleaning method according to the present invention. As shown in FIG. 4, this scrub cleaning apparatus includes a plurality of (e.g., four as illustrated) horizontally movable spindles 10 for supporting a periphery of a substrate W, such as a semiconductor wafer, with its front surface facing upwardly, and horizontally rotating the substrate W, a vertically movable upper roll holder 12 disposed above the substrate W supported by the spindles 10, and a vertically movable lower roll holder 14 disposed below the substrate W supported by the spindles 10.

A long cylindrical upper roll cleaning member (roll sponge) 16, e.g., made of PVA, is rotatably supported by the upper roll holder 12. A long cylindrical lower roll cleaning member (roll sponge) 18, e.g., made of PVA, is rotatably supported by the lower roll holder 14. In this embodiment, the roll sponges, e.g., made of PVA are used as the roll cleaning members 16, 18. Instead of the roll sponges, it is possible to use roll brushes, each having a surface brush, as the roll cleaning members 16, 18.

The upper roll holder 12 is coupled to a not-shown drive mechanism for vertically moving the upper roll holder 12 and rotating the upper roll cleaning member 16, rotatably supported by the upper roll holder 12, in the direction shown by the arrow F₁. The lower roll holder 14 is coupled to a not-shown drive mechanism for vertically moving the lower roll holder 14 and rotating the lower roll cleaning member 18, rotatably supported by the lower roll holder 14, in the direction shown by the arrow F₂.

An upper cleaning liquid supply nozzle 20, for supplying a cleaning liquid to a front surface (upper surface) of the substrate W, is disposed above the substrate W supported by the spindles 10, while a lower cleaning liquid supply nozzle 22, for supplying a cleaning liquid to a back surface (lower surface) of the substrate W, is disposed below the substrate W supported by the spindles 10.

In the above-structured scrub cleaning apparatus, a peripheral portion of the substrate W is located in an engagement groove 24a formed in a circumferential surface of a spinning top 24 provided at the top of each spindle 10. By spinning the spinning tops 24 while pressing them inwardly against the peripheral portions of the substrate W, the substrate W is rotated horizontally in the direction shown by the arrow E. In this embodiment, two of the four spinning tops 24 apply a rotational force to the substrate W, while the other two spinning tops 24 each function as a bearing and receive the rotation of the substrate W. It is also possible to couple all the spinning tops 24 to a drive mechanism so that they all apply a rotational force to the substrate W.

While horizontally rotating the substrate W and supplying a cleaning liquid (liquid chemical) from the upper cleaning liquid supply nozzle 20 to the front surface (upper surface) of the substrate W, the upper roll cleaning member 16 is rotated and lowered to bring it into contact with the front surface of the rotating substrate W, thereby performing scrub cleaning of the front surface of the substrate W with the upper roll cleaning member 16 in the presence of the cleaning liquid. The length of the upper roll cleaning member 16 is set slightly larger than the diameter of the substrate W. The upper roll cleaning member 16 is disposed in such a position that its central axis (rotational axis) O₁ is substantially perpendicular to the rotational axis O₂ of the substrate W, and that it extends over the entire length of the diameter of the substrate W. This enables simultaneous cleaning of the entire front surface of the substrate W.

Simultaneously, while supplying a cleaning liquid from the lower cleaning liquid supply nozzle 22 to the back surface (lower surface) of the substrate W, the lower roll cleaning member 18 is rotated and raised to bring it into contact with the back surface of the rotating substrate W, thereby performing scrub cleaning of the back surface of the substrate W with the lower roll cleaning member 18 in the presence of the cleaning liquid. The length of the lower roll cleaning member 18 is set slightly larger than the diameter of the substrate W. As with the above-described cleaning of the front surface of the substrate W, the entire back surface of the substrate W can be cleaned simultaneously.

When cleaning the front surface of the substrate W with the upper roll cleaning member (hereinafter simply referred to as “roll cleaning member”) 16 in the above-described manner, the substrate W and the roll cleaning member 16 make contact with each other in a cleaning area 30 having a length L, extending linearly in the axial direction of the roll cleaning member 16 over the entire length of the substrate W in the diametrical direction, as shown in FIG. 5, and the surface of the substrate W is scrub-cleaned in the cleaning area 30.

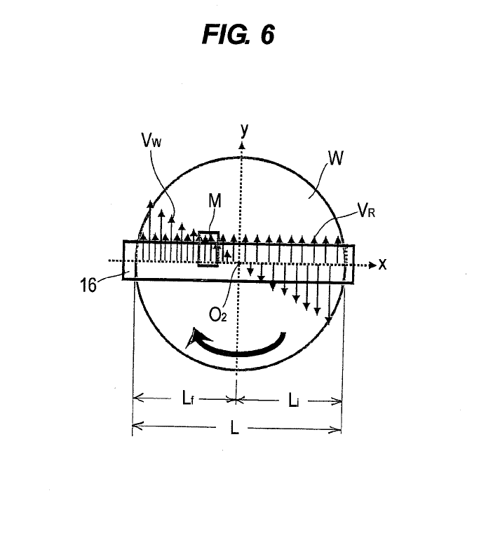

As shown in FIG. 6, when the substrate W rotates on the rotational axis O₂, the magnitude of the rotational velocity V_{W} of the substrate W in the cleaning area 30 is zero on the rotational axis O₂ of the substrate W, and the direction (cleaning direction) of the rotational velocity V_{W} of the substrate W on one side of the rotational axis O₂ is opposite to that on the opposite side of the rotational axis O₂. On the other hand, when the roll cleaning member 16 rotates, the magnitude of the rotational velocity V_{R} of the roll cleaning member 16 in the cleaning area 30 is constant over the entire length of the cleaning area 30, and the direction (cleaning direction) of the rotational velocity V_{R} is the same on both sides of the rotational axis O₂ of the substrate W.

In FIGS. 5 and 6, the x-axis extends along the cleaning area 30, while the y-axis extends on the surface of the substrate W in a direction perpendicular to the x-axis. The rotational axis O₂ of the substrate W passes through the origin of the x-y plane. The same applies to the rest of this description.

Therefore, the cleaning area 30 can be classified into a forward-direction cleaning area 32, having a length L_{f} and lying on one side of the rotational axis O₂ of the substrate W, in which the direction of the rotational velocity V_{W} of the substrate W is the same as the direction of the rotational velocity V_{R} of the roll cleaning member 16, and an opposite-direction cleaning area 34, having a length Lᵢ and lying on the opposite side of the rotational axis O₂ of the substrate W, in which the direction of the rotational velocity V_{W} of the substrate W is opposite to the direction of the rotational velocity V_{R} of the roll cleaning member 16.

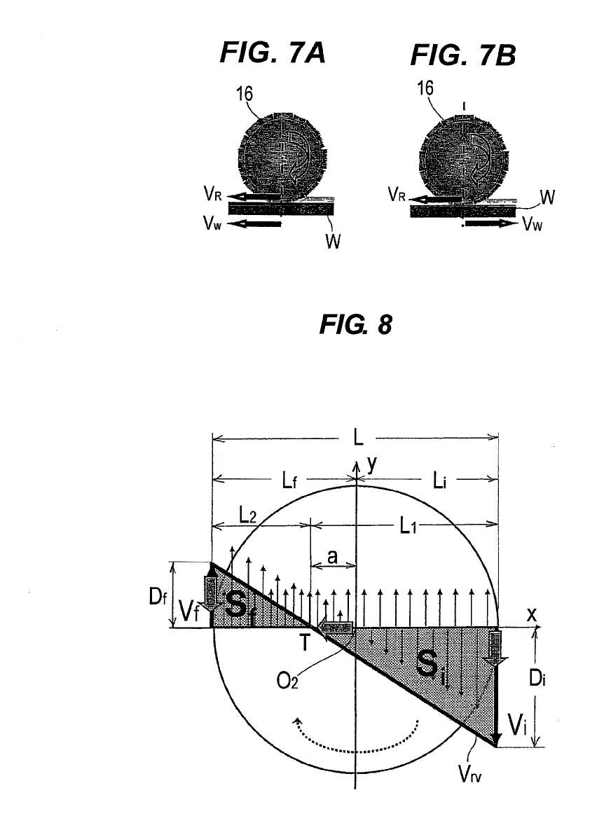

As shown in FIG. 7A, in the forward-direction cleaning area 32, the magnitude of the relative velocity (the relative rotational velocity) between the rotational velocity V_{W} of the substrate W and the rotational velocity V_{R} of the roll cleaning member 16 is the absolute value of the difference between the magnitudes of two rotational velocities and is relatively low. On the other hand, in the opposite-direction cleaning area 34, the magnitude of the relative velocity (the relative rotational velocity) between the rotational velocity V_{W} of the substrate W and the rotational velocity V_{R} of the roll cleaning member 16 is the sum of the magnitudes of the two rotational velocities and is relatively high, as shown in FIG. 7B. Thus, depending on the magnitude of the rotational velocity V_{W} of the substrate W and the magnitude of the rotational velocity V_{R} of the roll cleaning member 16, there may exist a region M where the magnitude of the relative velocity between them is zero (V_{W}=V_{R}) and the substrate W is not cleaned.

It is considered that in, the non-cleaning region M, corresponding to the below-described direction-reversing point T, at which the direction of cleaning reverses, and its vicinity, the substrate W is merely in contact with the roll cleaning member 16, and no scrub cleaning of the surface of the substrate W with the roll cleaning member 16 is performed. Rather, it is possible that residues, etc. which have adhered to the roll cleaning member 16 may re-adhere to the surface of the substrate W by contact with the substrate surface, thus causing back contamination of the surface of the substrate W.

When a direction-reversing point T, at which the relative velocity between the substrate W and the roll cleaning member 16 is zero and the direction of cleaning reverses, exists on the cleaning area 30 having a length L in a position at a distance “a” from the rotational axis O₂ of the substrate W, as shown in FIG. 8, the length L₁ (mm) of an opposite relative movement area lying on the opposite-direction cleaning area 34 side of the direction-reversing point T, the length L₂ (mm) of a forward relative movement area lying on the forward-direction cleaning area 32 side of the direction-reversing point T, the maximum relative velocity Vᵢ (mm/sec) of the relative velocity (relative movement velocity) Vᵣᵥ in the opposite-direction cleaning area 34 and the maximum relative velocity V_{f} (mm/sec) of the relative velocity Vᵣᵥ in the forward-direction cleaning area 32 are used to determine the area Sᵢ (mm²) of the triangle with the length L₁ as the base and the relative movement distance Dᵢ (mm) per second, determined by the relative velocity Vᵢ, as the height, and to determine the area S_{f} (mm₂) of the triangle with the length L₂ as the base and the relative movement distance D_{f} (mm) per second, determined by the relative velocity V_{f}, as the height. The total area Sᵣᵥ (=Sᵢ+S_{f}) of the two triangles is used as the amount S of relative velocity in an evaluation of the degree of cleaning.

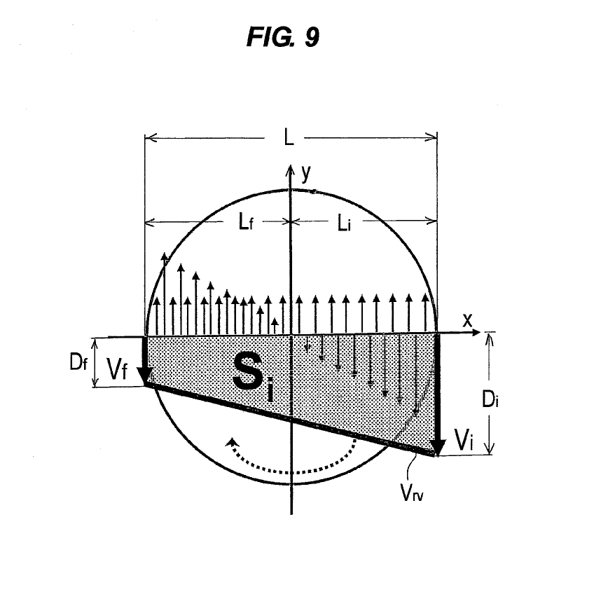

When a direction-reversing point T, at which the relative velocity between the substrate W and the roll cleaning member 16 is zero and the direction of cleaning reverses, does not exist (the direction of cleaning does not reverse) on the cleaning area 30 having a length L, as shown in FIG. 9, the area Sᵣᵥ (=Sᵢ) of the trapezoid with the length L (mm) of the cleaning area 30 as the height, the relative movement distance Dᵢ (mm) per second, determined by the maximum relative velocity Vᵢ of the relative velocity Vᵣᵥ in the opposite-direction cleaning area 34, as the upper base, and the relative movement distance D_{f} (mm) per second, determined by the maximum relative velocity V_{f} of the relative velocity Vᵣᵥ in the forward-direction cleaning area 32, as the lower base, is used as the amount S of relative velocity in an evaluation of the degree of cleaning.

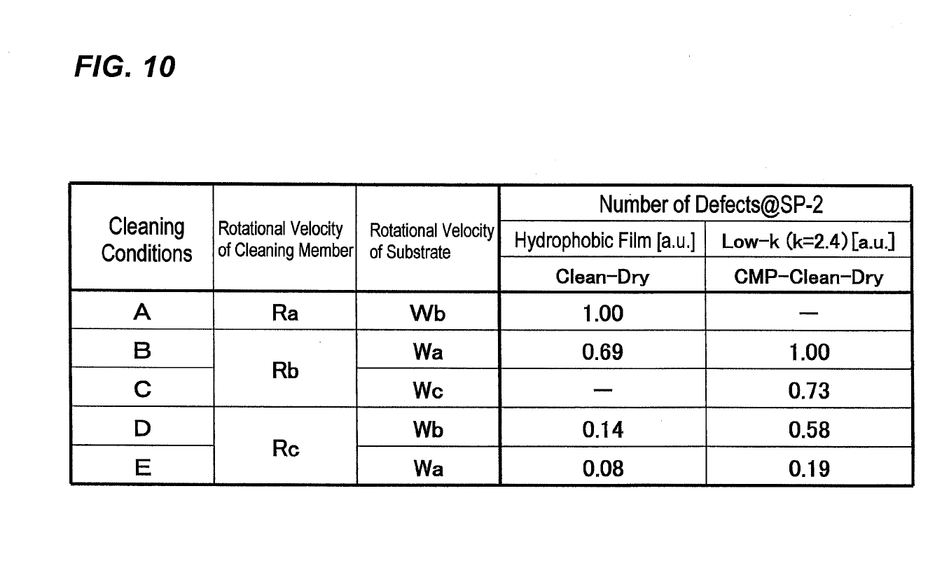

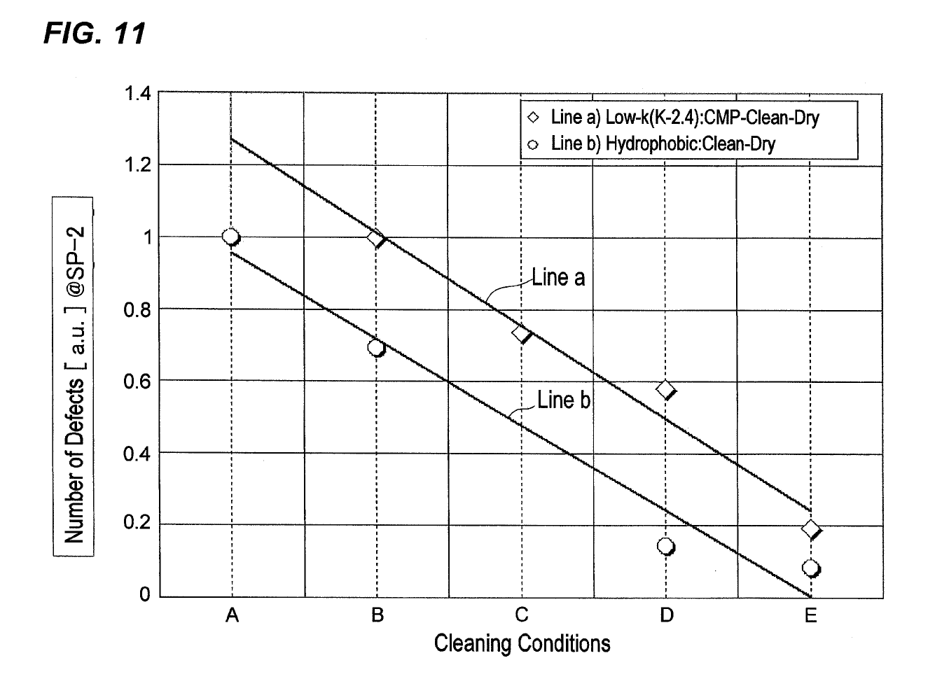

FIG. 10 shows various cleaning conditions which were used in cleaning of a surface of a low-k film (contact angle ≧25°) on a substrate and a surface of another common hydrophobic film (contact angle ≧25°) on a substrate, carried out by using the substrate cleaning apparatus shown in FIG. 4. As shown in FIG. 10, the rotational velocity of the roll cleaning member 16 is Ra and the rotational velocity of a substrate W is Wb in the cleaning conditions A. The rotational velocity of the roll cleaning member 16 is Rb in both of the cleaning conditions B and C, and the rotational velocity of a substrate W is Wa in the cleaning conditions B and We in the cleaning conditions C. The rotational velocity of the roll cleaning member 16 is Re in both of the cleaning conditions D and E, and the rotational velocity of a substrate W is Wb in the cleaning conditions D and Wa in the cleaning conditions E. The ratio between the rotational velocities Ra, Rb and Rc of the roll cleaning member 16 is set as follows: Ra:Rb:Rc=1:20:40. The ratio between the rotational velocities Wa, Wb and We of a substrate W is set as follows: Wa:Wb:Wc=1:2:3.

FIG. 10 shows the results of measurement of the number of defects remaining on a surface after cleaning of the surface of a common hydrophobic film on a substrate, carried out under the cleaning conditions A, B, D or E. For the respective cleaning conditions, the number of defects is expressed in terms of the ratio (arbitrary unit) to the number of defects measured after cleaning carried out under the cleaning conditions A. FIG. 10 also shows the results of measurement of the number of defects remaining on a surface after cleaning of the surface of a low-k film on a substrate, carried out under the cleaning conditions B, C, D or E. For the respective cleaning conditions, the number of defects is expressed in terms of the ratio (arbitrary unit) to the number of defects measured after cleaning carried out under the cleaning conditions B.

FIG. 11 is a graph showing the relationship between the cleaning conditions shown in FIG. 10 and the number of defects remaining on a substrate surface after cleaning carried out under the cleaning conditions, with the abscissa representing the cleaning conditions and the ordinate representing the number of defects (arbitrary unit). As can be seen in FIG. 11, the number of defects remaining on a substrate surface after cleaning of the surface of the common hydrophobic film on the substrate, carried out under the cleaning conditions A, B, D or E, lies on a straight line a, while the number of defects remaining on a substrate surface after cleaning of the surface of the low-k film on the substrate, carried out under the cleaning conditions B, C, D or E, lies on a straight line b. The line a and the line b are parallel to each other. Thus, there is a correlation between the number of defects on a substrate after cleaning of the surface of the low-k film and the number of defects on a substrate after cleaning of the surface of the common hydrophobic film. As will be appreciated from this, the degree of cleaning for the low-k material can be evaluated based on an evaluation of the degree of cleaning for the common hydrophobic film.

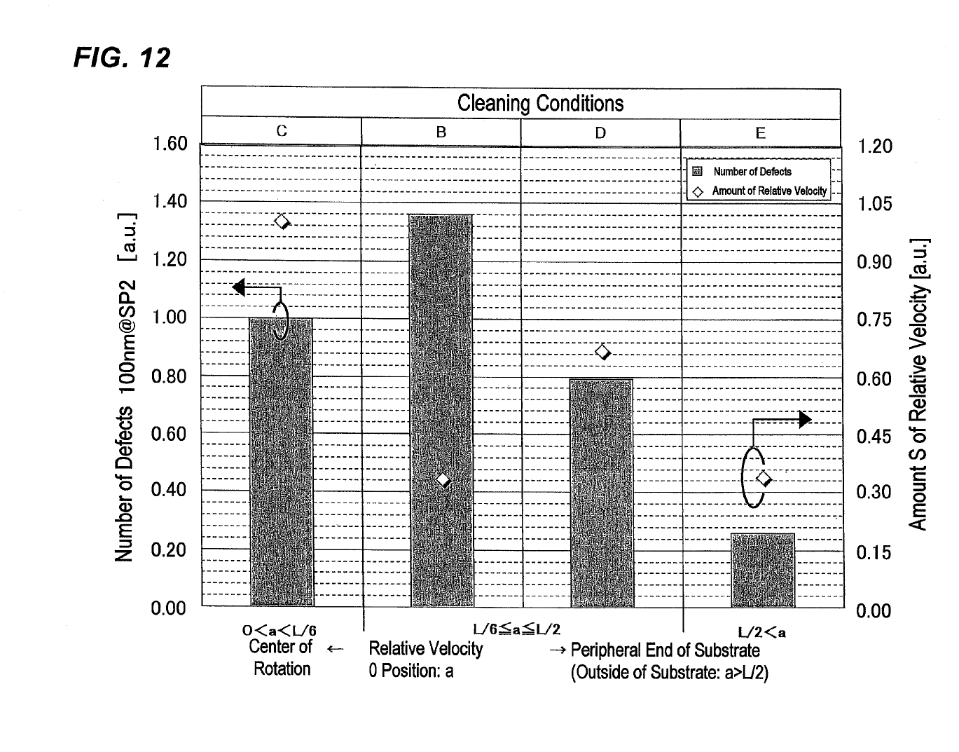

FIG. 12 is a graph showing the number of defects, measured with a defect measuring device, remaining on a substrate surface after cleaning of the surface of the low-k film on the substrate, carried out under the cleaning conditions B, C, D or E, and the amount S of relative velocity, determined by the method illustrated in FIG. 8 or 9, together with the cleaning conditions B, C, D or E. The amount S of relative velocity is expressed in terms of the ratio (arbitrary unit) to the amount of relative velocity in the cleaning conditions C. FIG. 12 also shows the distance “a” (see FIG. 8) from the rotational axis O₂ of the substrate to the direction-reversing point T at which the relative velocity between the roll cleaning member and the substrate is zero, the distance being expressed in terms of the ratio to the length L of the cleaning area.

As can be seen in FIG. 12, the number of defects remaining on a substrate surface after cleaning is not proportional to the distance “a” from the rotational axis O₂ of the substrate to the direction-reversing point T at which the relative velocity is zero, nor proportional to the amount S of relative velocity. As will be appreciated also from this fact, it is difficult to predict cleaning characteristics which enable a reduction in the number of defects remaining on a substrate surface in a substrate cleaning method which performs scrub cleaning of a substrate surface by bringing a roll cleaning member, having a length that covers the diameter of the substrate, into contact with the substrate surface in a cleaning area along the axial direction of the roll cleaning member while rotating the roll cleaning member and the substrate each in one direction.

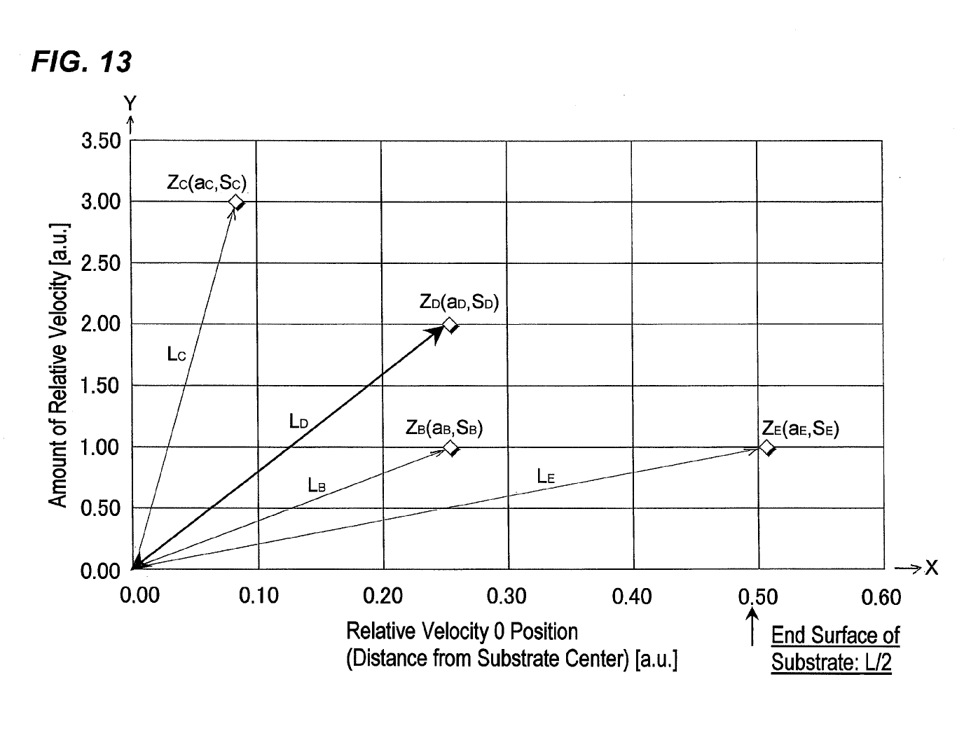

FIG. 13 is a graph obtained by plotting cleaning points, corresponding to the cleaning conditions shown in FIG. 12, on an X-Y plane, with the X coordinate representing the distance “a” from the rotational axis O₂ of the substrate to the direction-reversing point T at which the relative velocity between the roll cleaning member and the substrate is zero, and the Y coordinate representing the amount S of relative velocity. In particular, the cleaning conditions B are shown as a cleaning point Z_{B} with coordinates (a_{B}, S_{B}), the cleaning conditions C as a cleaning point Z_{C} with coordinates (a_{C}, S_{C}), the cleaning conditions D as a cleaning point Z_{D} with coordinates (a_{D}, S_{D}), and the cleaning conditions E as a cleaning point Z_{E} with coordinates (a_{E}, S_{E}). The distances L_{B}, L_{C}, L_{D} and L_{E} from the origin of the X-Y plane to the cleaning points Z_{B}, Z_{C}, Z_{D} and Z_{E} are also shown in the graph.

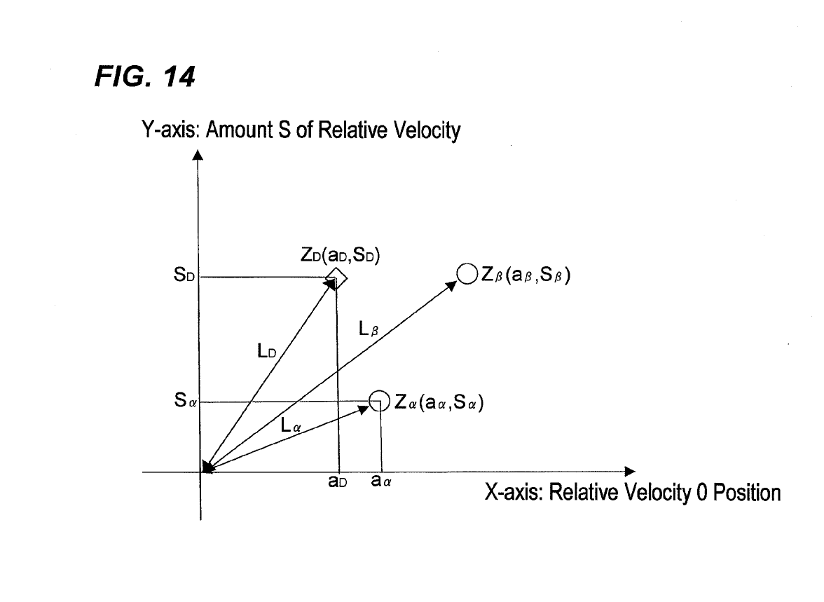

As shown in FIG. 14, the cleaning point Z_{D}, corresponding to the cleaning conditions D, for example, lies at a distance a_{D} from the Y-axis in the X-axis direction and at a distance S_{D} from the X-axis in the Y-axis direction; the distance L_{D} from the origin of the X-Y plane to the cleaning point Z_{D} can be determined by the following formula (1). Similarly, for a cleaning point Z_{α} with coordinates (a_{α}, S_{α}), corresponding to arbitrary cleaning conditions α and lying at a distance a_{α} from the Y-axis in the X-axis direction and at a distance S_{α} from the X-axis in the Y-axis direction, the distance L_{α} from the origin of the X-Y plane to the cleaning point Z_{α} can be determined by the following formula (2).

L_{D}=\sqrt{(a_{D})²+(S_{D})²} (1)

L_{α}=\sqrt{(a_{α})²+(S_{α})²} (2)

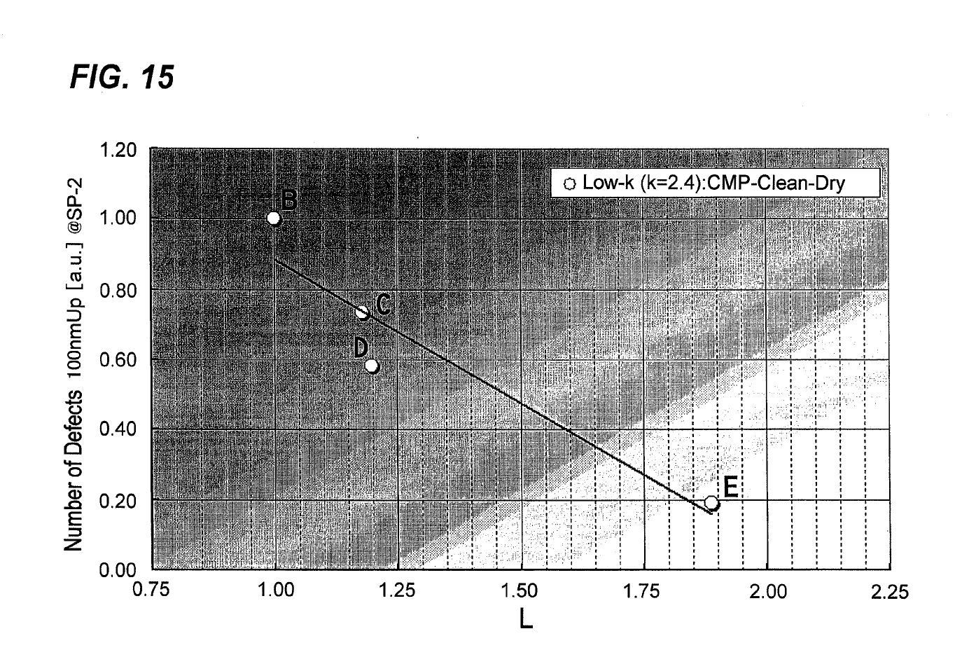

FIG. 15 is a graph showing the relationship between the distance L from the origin of the X-Y plane to a cleaning point and the number of defects remaining on a substrate surface after cleaning. In the graph, the distances L_{B}, L_{C}, L_{D} and L_{E} from the origin of the X-Y plane to the cleaning points Z_{B}, Z_{C}, Z_{D} and Z_{E}, corresponding to the cleaning conditions B, C, D and E, shown in FIG. 13, are plotted in the abscissa (distance L), and the numbers of defects remaining on a substrate surface after cleaning, measured for the cleaning conditions B, C, D and E, are plotted in the ordinate. In FIG. 15, the distance L is expressed in terms of the ratio (arbitrary unit) to the distance L_{B} from the origin of the X-Y plane to the cleaning point Z_{B}. The points B, C, D and E represent the cleaning conditions B, C, D and E.

As can be seen in FIG. 15, the number of defects remaining on a substrate surface decreases with increase in the distance L (L_{B}<L_{C}<L_{D}<L_{E}) from the origin of the X-Y plane to a cleaning point Z. This indicates that the use of cleaning conditions having a larger distance L from the origin of the X-Y plane to a cleaning point Z enhances the overall cleaning characteristics, determined by the total cleaning performance of the cleaning performance of a cleaning liquid and the physical cleaning performance and by the effect of preventing residues, etc. from re-adhering to a substrate surface.

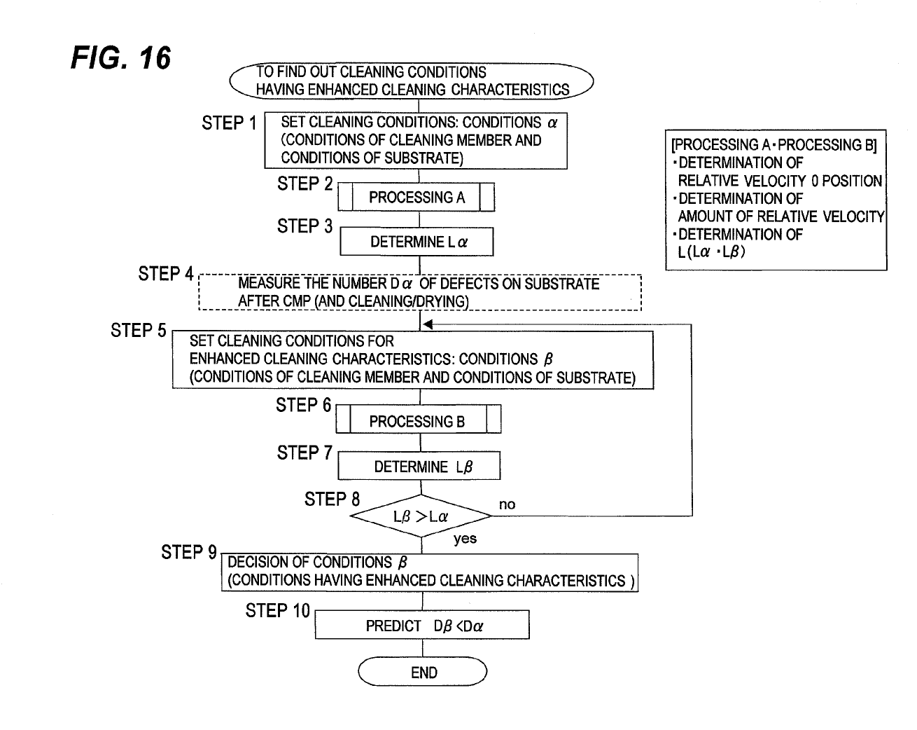

Considering above, the cleaning performance prediction method of the present invention will now be described with reference to the flow chart shown in FIG. 16 and to FIG. 13. First, cleaning conditions α, including the rotational velocity of a roll cleaning member, the rotational velocity of a substrate, the condition (diameter) of the roll cleaning member, the condition (diameter) of the substrate, etc., are determined (step 1). Next, based on the cleaning conditions α, the distance a_{α} from the rotational axis of the substrate to the direction-reversing point at which the relative velocity between the roll cleaning member and the substrate is zero, and the amount S_{α} of relative velocity are determined (step 2). A cleaning point Z_{α} (a_{α}, S_{α}), with the distance a_{α} as an X-coordinate and the amount S_{α} of relative velocity as a Y-coordinate, is plotted on an X-Y plane, as shown in FIG. 13, to determine the distance L_{α} from the origin of the X-Y plane to the cleaning point Z_{α} (a_{α}, S_{α}) (step 3). If necessary, the substrate surface, e.g., after CMP is actually cleaned with this cleaning conditions α and dried, and the number D_{α} of defects remaining on the substrate surface is measured (step 4).

Next, cleaning conditions β, different from the cleaning conditions α and including the rotational velocity of the roll cleaning member, the rotational velocity of the substrate, the condition (diameter) of the roll cleaning member, the condition (diameter) of the substrate, etc., are determined (step 5). Next, based on the cleaning conditions β, the distance a_{β} from the rotational axis of the substrate to the direction-reversing point at which the relative velocity between the roll cleaning member and the substrate is zero, and the amount S_{β} of relative velocity are determined (step 6). A cleaning point Z_{β} (a_{β}, S_{β}), with the distance a_{β} as an X-coordinate and the amount S_{β} of relative velocity as a Y-coordinate, is plotted on an X-Y plane, as shown in FIG. 13, to determine the distance L_{β} from the origin of the X-Y plane to the cleaning point Z_{β} (a_{β}, S_{β}) (step 7).

The distance L_{α} from the origin of the X-Y plane to the cleaning point Z_{α} (a_{α}, S_{α}) is compared with the distance L_{β} from the origin of the X-Y plane to the cleaning point Z_{β} (a_{β}, S_{β}) (step 8). If the distance L_{α} is larger than the distance L_{β} (L_{α}≧L_{β}), then the process is returned to step 5. If the distance L_{β} is larger than the distance L_{α} (L_{β}>L_{α}), then the cleaning conditions β are determined to be superior in the cleaning characteristics to the cleaning conditions a (step 9). Thus, the number D_{β} of defects remaining on the substrate surface after cleaning of the substrate surface, carried out under the cleaning conditions β, is predicted to be smaller than the number D_{α} of defects (D_{β}<D_{α}) remaining on the substrate surface after cleaning of the substrate surface, carried out under the cleaning conditions α.

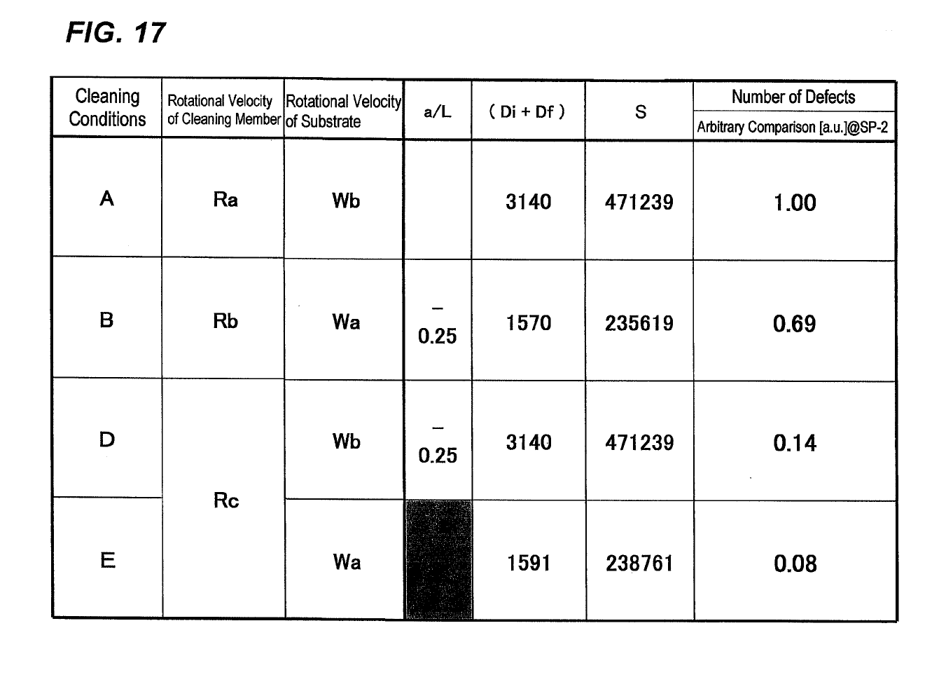

FIG. 17 shows the number of defects remaining on a substrate surface after cleaning of the surface of a common hydrophobic film on the substrate having a diameter of 300 mm, carried out under the cleaning conditions A, B, D or E, together with the ratio (a/L) of the distance “a” from the rotational axis of the substrate to a direction-reversing point, at which the relative velocity between a roll cleaning member and the substrate is zero and the direction of cleaning reverses, to the length L (=300 mm) of the cleaning area, the sum (Dᵢ+D_{f}) of the relative movement distance Dᵢ (mm) per second and the relative movement distance D_{f} (mm) per second shown in FIGS. 8 and 9, and the amount (S) of relative velocity determined by the method shown in FIG. 8 or 9. In FIG. 17, the number of defects is expressed in terms of the ratio (arbitrary unit) to the number of defects measured after cleaning carried out under the cleaning conditions A.

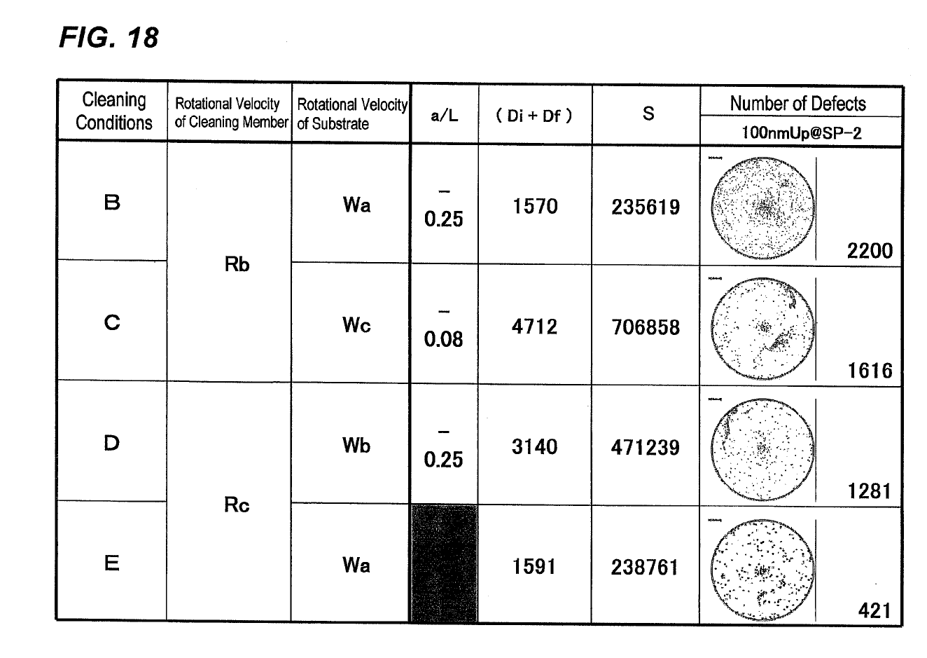

FIG. 18 shows the number of defects remaining on a substrate surface after cleaning of the surface of a low-k film on the substrate having a diameter of 300 mm, carried out under the cleaning conditions B, C, D or E, together with the ratio (a/L) of the distance “a” from the rotational axis of the substrate to a direction-reversing point, at which the relative velocity between a roll cleaning member and the substrate is zero and the direction of cleaning reverses, to the length L (=300 mm) of the cleaning area, the sum (Dᵢ+D_{f}) of the relative movement distance Dᵢ (mm) per second and the relative movement distance D_{f} (mm) per second shown in FIGS. 8 and 9, and the amount (S) of relative velocity determined by the method shown in FIG. 8 or 9. FIG. 18 also shows, together with the number of defects, the state of the distribution of defects remaining on the substrate surface after cleaning carried out under the cleaning conditions B, C, D or E.

In FIGS. 17 and 18, the ratio between the rotational velocities Ra, Rb and Rc of the roll cleaning member and the ratio between the rotational velocities Wa, Wb and We of the substrate are the same as described above with reference to FIG. 10.

From the above, when using cleaning conditions in which, as in the cleaning conditions C, for example, a direction-reversing point T, at which the direction of cleaning reverses, exists and the ratio of the distance “a” from the rotational axis of a substrate W to the direction-reversing point T to the length L of the cleaning area is less than ⅙ (0<a<L/6), the number of defects remaining on the substrate surface after cleaning can be made not more than the allowable value by setting the rotational velocity of the substrate W and the rotational velocity of the roll cleaning member 16 in such a manner that the following relational expressions are satisfied: (Dᵢ+D_{f})/L≧8, i.e., the value obtained by dividing the sum of the relative movement distances Dᵢ and D_{f}, determined by the maximum relative velocities Vᵢ and V_{f} between the substrate W and the roll cleaning member 16 in the opposite-direction cleaning area and the forward-direction cleaning area, by the length L of the cleaning area, is not less than 8; and S≧2000L (mm²), i.e., the amount S of relative velocity, determined as the total area Sᵣᵥ of the area Sᵢ and the area S_{f} of the triangles shown in FIG. 8, is at least 2000 times the length L of the cleaning area.

When using cleaning conditions in which, as in the cleaning conditions D, for example, a direction-reversing point T, at which the direction of cleaning reverses, exists and the ratio of the distance “a” from the rotational axis of a substrate W to the direction-reversing point T to the length L of the cleaning area is not less than ⅙ (L/6<a<L/2), the number of defects remaining on the substrate surface after cleaning can be made not more than the allowable value by setting the rotational velocity of the substrate W and the rotational velocity of the roll cleaning member 16 in such a manner that the following relational expressions are satisfied: (Dᵢ+D_{f})/L≧8, i.e., the value obtained by dividing the sum of the relative movement distances Dᵢ and D_{f}, determined by the maximum relative velocities Vᵢ and V_{f} between the substrate W and the roll cleaning member 16 in the opposite-direction cleaning area and the forward-direction cleaning area, by the length L of the cleaning area, is not less than 8; and S≧1300L (mm²), i.e., the amount S of relative velocity, determined as the total area Sᵣᵥ of the area Sᵢ and the area S_{f} of the triangles shown in FIG. 8, is at least 1300 times the length L of the cleaning area.

In the above cases, the rotational velocity of the substrate W and the rotational velocity of the roll cleaning member 16 are preferably set in such a manner that the following relational expression is satisfied: Dᵢ/L≧6, i.e., the value obtained by dividing the relative movement distance Dᵢ, determined by the maximum relative velocity Vᵢ between the substrate W and the roll cleaning member 16 in the opposite-direction cleaning area, by the length L of the cleaning area, is not less than 6.

The number of defects remaining on the substrate surface after cleaning can be made not more than the allowable value also by setting the rotational velocity of the substrate W and the rotational velocity of the roll cleaning member 16 in such a manner that a direction-reversing point T, at which the direction of cleaning reverses, does not exist on the cleaning area as in the cleaning conditions E, for example.

When using such cleaning conditions in which a direction-reversing point T, at which the direction of cleaning reverses, does not exist on the cleaning area, the rotational velocity of the substrate W and the rotational velocity of the roll cleaning member 16 are preferably set in such a manner that the following relational expression is satisfied: (Dᵢ+D_{f})/L≧4, i.e., the value obtained by dividing the sum of the relative movement distances Dᵢ and D_{f}, determined by the maximum relative velocities Vᵢ and V_{f} between the substrate W and the roll cleaning member 16 in the opposite-direction cleaning area and the forward-direction cleaning area, by the length L of the cleaning area, is not less than 4. More preferably, the rotational velocity of the substrate W and the rotational velocity of the roll cleaning member 16 are set in such a manner that the following relational expression is satisfied: S≧600L (mm²), i.e., the amount S of relative velocity, determined as the area Sᵣᵥ (=Sᵢ) of the trapezoid shown in FIG. 9, is at least 600 times the length L of the cleaning area.

The substrate processing method of the present invention performs cleaning of a surface of a substrate W e.g., by using the substrate cleaning apparatus shown in FIG. 4 and by setting the rotational velocity of the substrate W and the rotational velocity of the roll cleaning member 16 to cleaning conditions which, like the cleaning conditions C, D or E, can make the number of defects, remaining on the substrate surface after cleaning, not more than the allowable value.

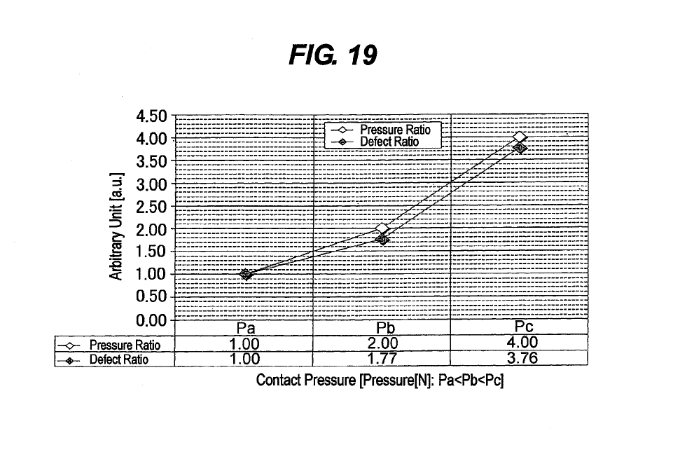

FIG. 19 is a graph showing the relationship of the contact pressure between a substrate W and the roll cleaning member 16 with the number of defects remaining on the surface of the substrate W after cleaning with the roll cleaning member 16, carried out at varying contact pressures of 3N, 6N and 12N. In the abscissa of the graph of FIG. 19, the contact pressure is expressed in terms of the pressure ratio to the contact pressure 3N, i.e., the pressure ratios “1.00”, “2.00” and “4.00” correspond to the contact pressures 3N, 6N and 12N, while in the ordinate the number of defects is expressed in terms of the ratio (arbitrary unit) to the number of defects after cleaning carried out at a contact pressure of 3N.

As can be seen in FIG. 19, the cleaning effect rather decreases when the contact pressure between a substrate W and the roll cleaning member 16 is increased in an attempt to increase the physical cleaning effect.

The data thus indicates that merely increasing the contact pressure between a substrate and a roll cleaning member, e.g., a PVA sponge, in contact cleaning of a hydrophobic surface for increasing the physical cleaning performance would be undesirable, assuming that the overall cleaning characteristics (effect) is determined by the total cleaning performance of the cleaning performance of a cleaning liquid and the physical cleaning performance and by the effect of preventing residues, etc. from re-adhering to a substrate surface. There is a fear that contamination of the substrate by the re-adhesion of residues may exceed the cleaning effect in contact cleaning of a hydrophobic surface, such as the surface of a low-k film, carried out at an excessively high contact pressure. Thus, for contact cleaning of a hydrophobic surface, it is preferred to use a low contact pressure of not more than 6N, more preferably not more than 3N, and to optimize other conditions so as to enhance the overall cleaning performance.

By performing scrub cleaning of a surface of a substrate W in the above-described manner, the surface of the substrate W can be cleaned with a high degree of cleaning even when the substrate W has hydrophobic surface properties. Thus, even a substrate surface which is in the process of forming damascene interconnects using copper as an interconnect metal and a low-k film as an insulating film and on which the copper and the low-k film, both having hydrophobic surface properties, are exposed after CMP, can be cleaned with a high degree of cleaning, i.e., with only a small number of defects remaining on the substrate surface, by carrying out scrub cleaning of the substrate surface in the above-described manner.

While the present invention has been described with reference to preferred embodiments, it is understood that the present invention is not limited to the embodiments described above, but is capable of various changes and modifications within the scope of the inventive concept as expressed herein.

What is claimed is:

1. A method of predicting cleaning performance in scrub cleaning of a surface of a substrate, carried out by positioning a role cleaning member, having a length that covers a diameter of the substrate, on the rotational axis of the substrate, and rotating the roll cleaning member and the substrate each in one direction while keeping the roll cleaning member in contact with the surface of the substrate in a cleaning area along the axial direction of the roll cleaning member, said method comprising:
determining a first distance from the origin of an X-Y plane to a first cleaning point on the X-Y plane, the X coordinate of the first cleaning point being the distance from the rotational axis of the substrate to a direction-reversing point on the cleaning area at which the relative velocity between the roll cleaning member and the substrate is zero and the direction of cleaning reverses, the Y coordinate of the first cleaning point being the amount of the relative velocity, defined in terms of an area, and the X-Y coordinates being determined for cleaning of the substrate to be carried out under first cleaning conditions in which the roll cleaning member and the substrate are rotated each at a predetermined rotational velocity;
determining a second distance from the origin of the X-Y plane to a second cleaning point on the X-Y plane, the X coordinate of the second cleaning point being the distance from the rotational axis of the substrate to a direction-reversing point on the cleaning area at which the relative velocity between the roll cleaning member and the substrate is zero and the direction of cleaning reverses, the Y coordinate of the second cleaning point being the amount of the relative velocity, defined in terms of an area, and the X-Y coordinates being determined for cleaning of the substrate to be carried out under second cleaning conditions different from the first cleaning conditions;
and, if the second distance is longer than the first distance, predicting that the number of defects remaining on the substrate surface will be smaller when cleaning the substrate under the second cleaning conditions than when cleaning the substrate under the first cleaning conditions.

2. A substrate cleaning method comprising:
positioning a role cleaning member, having a length that covers a diameter of a substrate, on the rotational axis of the substrate, and rotating the roll cleaning member and the substrate each in one direction while keeping the roll cleaning member in contact with a surface of the substrate in a cleaning area along the axial direction of the roll cleaning member, thereby performing scrub cleaning of the surface of the substrate with the roll cleaning member,
wherein the roll cleaning member and the substrate are rotated in such a manner that the following relational expressions are satisfied:
0<a<L/6,
(Dᵢ+D_{f})≧8L,
where D_{f} (mm) is a relative movement distance per second, determined by the maximum relative velocity V_{f} (mm/sec) in a forward-direction cleaning area, where the relative velocity between the roll cleaning member and the substrate is relatively low, of the cleaning area, Dᵢ (mm) is a relative movement distance per second, determined by the maximum relative velocity Vᵢ (mm/sec) in an opposite-direction cleaning area, where the relative velocity between the roll cleaning member and the substrate is relatively high, of the cleaning area, L (mm) is the length of the cleaning area, and a (mm) is the distance from the rotational axis of the substrate to a direction-reversing point on the cleaning area at which the relative velocity between the roll cleaning member and the substrate is zero and the direction of cleaning reverses; and
S≧2000L,
where S (mm²) is the amount of relative velocity, which is the total area Sᵣᵥ of the following areas Sᵢ and S_{f}: the area Sᵢ (mm²) of a triangle with a length L₁ as the base and the relative movement distance Dᵢ (mm) per second, determined by the maximum relative velocity Vᵢ (mm/sec), as the height, the length L₁ (mm) being the length of an opposite relative movement area of the cleaning area, lying on the opposite-direction cleaning area side of the direction-reversing point; and the area S_{f} (mm²) of a triangle with a length L₂ as the base and the relative movement distance D_{f} (mm) per second, determined by the maximum relative velocity V_{f} (mm/sec), as the height, the length L₂ (mm) being the length of a forward relative movement area of the cleaning area, lying on the forward-direction cleaning area side of the direction-reversing point.

3. A substrate cleaning method comprising:
positioning a role cleaning member, having a length that covers a diameter of a substrate, on the rotational axis of the substrate, and rotating the roll cleaning member and the substrate each in one direction while keeping the roll cleaning member in contact with a surface of the substrate in a cleaning area along the axial direction of the roll cleaning member, thereby performing scrub cleaning of the surface of the substrate with the roll cleaning member,
wherein the roll cleaning member and the substrate are rotated in such a manner that the following relational expressions are satisfied:
L/6≦a≦L/2,
(Dᵢ+D_{f})≧8L,
where D_{f} (mm) is a relative movement distance per second, determined by the maximum relative velocity V_{f} (mm/sec) in a forward-direction cleaning area, where the relative velocity between the roll cleaning member and the substrate is relatively low, of the cleaning area, Dᵢ (mm) is a relative movement distance per second, determined by the maximum relative velocity Vᵢ (mm/sec) in an opposite-direction cleaning area, where the relative velocity between the roll cleaning member and the substrate is relatively high, of the cleaning area, L (mm) is the length of the cleaning area, and a (mm) is the distance from the rotational axis of the substrate to a direction-reversing point on the cleaning area at which the relative velocity between the roll cleaning member and the substrate is zero and the direction of cleaning reverses; and
S≧1300L,
where S (mm²) is the amount of relative velocity, which is the total area Sᵣᵥ of the following areas Sᵢ and S_{f}: the area Sᵢ (mm²) of a triangle with a length L₁ as the base and the relative movement distance Dᵢ (mm) per second, determined by the maximum relative velocity Vᵢ (mm/sec), as the height, the length L₁ (mm) being the length of an opposite relative movement area of the cleaning area, lying on the opposite-direction cleaning area side of the direction-reversing point; and the area S_{f} (mm²) of a triangle with a length L₂ as the base and the relative movement distance D_{f} (mm) per second, determined by the maximum relative velocity V_{f} (mm/sec), as the height, the length L₂ (mm) being the length of a forward relative movement area of the cleaning area, lying on the forward-direction cleaning area side of the direction-reversing point.

4. A substrate cleaning method comprising:
positioning a role cleaning member, having a length that covers a diameter of a substrate, on the rotational axis of the substrate, and rotating the roll cleaning member and the substrate each in one direction while keeping the roll cleaning member in contact with a surface of the substrate in a cleaning area along the axial direction of the roll cleaning member, thereby performing scrub cleaning of the surface of the substrate with the roll cleaning member,
wherein the roll cleaning member and the substrate are rotated in such a manner that a direction-reversing point, at which the relative velocity between the substrate and the roll cleaning member is zero and the direction of cleaning reverses, does not exist on the cleaning area.

5. The substrate cleaning method according to claim 4, wherein the roll cleaning member and the substrate are rotated in such a manner that the following relational expression is satisfied:
(Dᵢ+D_{f})≧4L,
where D_{f} (mm) is a relative movement distance per second, determined by the maximum relative velocity V_{f} (mm/sec) in a forward-direction cleaning area, where the relative velocity between the roll cleaning member and the substrate is relatively low, of the cleaning area, Dᵢ (mm) is a relative movement distance per second, determined by the maximum relative velocity Vᵢ (mm/sec) in an opposite-direction cleaning area, where the relative velocity between the roll cleaning member and the substrate is relatively high, of the cleaning area, and L (mm) is the length of the cleaning area.

6. The substrate cleaning method according to claim 5, wherein the roll cleaning member and the substrate are rotated in such a manner that the following relational expression is satisfied:
S≧600L,
where S (mm²) is the amount of relative velocity, which is the area Sᵣᵥ of a trapezoid with the relative movement distance D_{f} (mm) per second, determined by the maximum relative velocity V_{f} (mm/sec), as the upper base, the relative movement distance Dᵢ (mm) per second, determined by the maximum relative velocity Vᵢ as the lower base, and the length L of the cleaning area as the height.
